(19) United States
(12) Patent Application Publication
(10) Pub. No.: US 2007/0236672 A1
(43) Pub. Date: Oct. 11, 2007

(54) Projector keyboard

(76) Inventors: Poh Keng Wee, Singapore (SG); Soon Pui Lee, Singapore (SG); Poh Keng Jin, Singapore (SG); Loo Kin Leong, Singapore (SG)

Correspondence Address: Mark Manley, 5205 W 32nd, Sedalia, MO, 65301, US

(21) Appl. No.: 11/401,707

(22) Filed: Apr. 10, 2006

(51) Int. Cl. G03B 21/00

(52) U.S. Cl. 353/122

(57) ABSTRACT

A computer keyboard with a keyboard housing having an aperture, a light source of adjustable position and angle, the light source located within the keyboard housing, an image insert located over the aperture and a reflector of adjustable angle located within the keyboard housing. The light source directs light to the reflector which then redirects the light through the aperture and image insert, resulting in an image being projected onto a surface exterior to and within the proximity of the computer keyboard.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

This invention relates to computer keyboards.

### BACKGROUND OF THE INVENTION

The proliferation of personal computers in homes and office environments has resulted in devices such as the computer keyboard being commonly used as convenient and affordable data input devices; as such, computer keyboards are commonly found in the home and office environments.

Businesses have recognized the potential benefits of placing various matter, including brands and advertising, on the surfaces of computer keyboards as a means of promoting their brands as well as a means of educating computer users and consumers concerning their products. Following this, businesses have been attempting to find new ways of displaying their trademarks and advertisements in or around these peripheral devices of the personal computers. Trademarks are commonly inscribed or printed at the side or corner of the housing of the keyboard, in prominent view of the computer user.

Further, computer users have sought to personalize their computer peripherals by placing their names or pictures onto the peripherals. This is usually performed by inscribing a name or by affixing a sticker onto the peripherals.

Once matter is printed, inscribed or affixed onto a keyboard housing, however, it would be difficult or inconvenient to change such matter. Stickers involve some manner of adhesive, which may leave a residue when removed.

Further, matter printed on a keyboard housing is susceptible to fading through everyday wear and tear; this is so especially for the case of a computer keyboard, which the computer user is in constant physical contact with.

As matter is physically imprinted or affixed by means of adhesive onto the computer keyboard, the physical size of the matter is limited to the amount of physical space available on the keyboard. In addition, the matter would generally be placed in a corner of computer keyboard or other areas where the matter would not impede the proper use and operation of computer keyboard.

The standard QWERTY computer keyboard features 101 keys; other modern computer keyboards feature additional keys or buttons on the keyboard housing, used in a multiplicity of ways, including gaining quick access to documents, application programs, the internet and the like. The addition of printed matter, including trademarks and personalized names, to the modern computer keyboards would serve to contribute towards visual ‘clutter’ of the keyboards.

### SUMMARY OF THE INVENTION

It is an object of the present invention to provide an apparatus that displays in a prominent manner matter, including advertising, trade marks and names within the view of a person using a computer and within the proximity of a keyboard or other peripheral such as a mouse or printer for example attached to the computer.

It is a further object to provide an apparatus as described in the previous paragraph and without the need for physically limiting the display of the matter to the available surface area of the housing of the keyboard, and possibly resulting in a generally cluttered appearance of the keyboard.

Yet another object of the present invention is to provide an apparatus that enables the changing of the matter in a clean, quick and convenient manner.

A further object of the present invention is to enable the user of the invention to change, adjust and control, within limits, the size and position of the matter.

To achieve the above objects, according to a preferred embodiment of the present invention, an apparatus comprises: a computer keyboard with an alpha-numeric section, the housing of the computer keyboard features an aperture over which resides an image insert, a light source residing within the housing of the computer keyboard and of adjustable angle and position, a reflector of adjustable angle residing within the housing, a block residing within the housing and a surface external to the housing upon which a resultant image is projected.

In a preferred embodiment, light emanating from the light source is directed to the reflector, and subsequently reflected through the aperture and image insert, resulting in a projected image on the image surface.

In order for clarity in projected image, it is desirable that a projected image is primarily the result of light reflected off the reflector and passing through the image insert, as ambient light from the light source may serve to compromise clarity in the projected image. The block serves to primarily prevent light from the light source to directly reach the aperture, resulting in a clearer projected image on the surface external to the housing of the keyboard.

In a preferred embodiment, an image insert is of transparent or semi-transparent material and may have matter printed inscribed on its surface, the matter being opaque or semi-transparent or being a combination of opaque and semi-transparent. The combination of some light passing through the image insert and some light being absorbed by the matter results in a desired projected image on the image surface.

### DESCRIPTION OF THE DRAWINGS

FIG. 1 is a cross-sectional side view showing an alpha-numeric section 44, keyboard housing 28, a light source 20, a vertical bracket 62, adjustor wheel 48, rod 63, platform 56, block 50, housing track 64, push knob 66, stop knob 68, reflector 22 affixed to lever 226, a wire 30 connected to the light source 20, an image insert 24 held over an aperture 38 by brackets 36, and a protective sheet 40.

FIG. 2 is an isometric view showing internal surface of a side of keyboard housing 28, reflector 22, rod 224, brackets 223 and protective sheet 40.

FIG. 3 is an isometric view showing the back surface 221 of reflector 22 affixed to the middle portion 2241 of rod 224; the back surface 221 is also affixed to the flat section 2261 of lever 226.

FIG. 4 is a view showing an external surface of keyboard housing 28, lever 2262 protruding out of the keyboard housing 28 through side slot 46, and image insert 24. Image 26 is formed on the surface ‘s’ upon which the keyboard housing 28 is sitting.

FIG. 5 is a side view showing platform 56, block 50, upper edge of block 502, adjustor wheel 48, cogwheel 484 affixed to surface 482, bracket 60, eye 601, and rod 63.

FIG. 6 is a further isometric side view displaying platform 56, block 50, adjustor wheel 48 and side surface 481, light source 20, wire 30, back stopper 54, front stopper 52, bracket 62, eye 621, a rod 63 and housing track 64.

FIG. 7 is a view of the external surface of the base of keyboard housing 28 showing stop knob 68, platform 56, push knob 66, housing track 64 and adjustor wheel 48.

FIG. 8 is a top view showing platform 56, stop knob 68, push knob 66, housing track 64, adjustor wheel 48, light source 20, bracket 60, bracket 62, and wire 30.

FIG. 9 is a top view of stop knob 68, push knob 66, protrusion lock 682, cavity 669 and circular knobs 667.

FIG. 10 is a side view showing platform 56, the back of light source 20, adjustor wheel 48, stopper 483, cogwheel 484, bracket 62, bracket 60 and a rod 63.

### DETAILED DESCRIPTION OF THE PREFERRED EMBODIMENTS

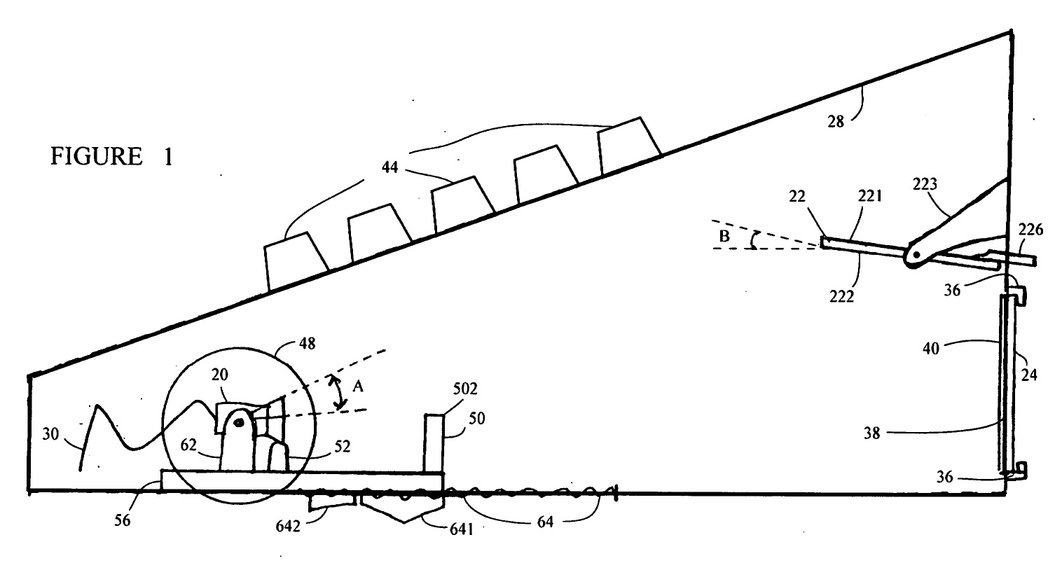

FIG. 1 shows a preferred embodiment, including a keyboard housing 28 with an aperture 38 covered by protective sheet 40, a light source 20 directing light to a reflector 22, an image insert 24 held in place over the aperture 38 by brackets 36.

Within the present invention, light source 20 is a durable source of light with low power consumption, and is of a predetermined brightness while generating minimal heat which would have little or no effect on any other components within the keyboard housing 28. In a preferred embodiment, light source 20 consists of a light-emitting diode or a plurality of light-emitting diodes. In an alternate embodiment, light source 20 consists of any other light emitting device. Light and heat from light source 20 should have no effect nor should it interfere with the workings of any printed circuit board or any other components within keyboard housing 28. The light emanating from light source 20 is of sufficient intensity for the resultant projected image 26 to appear clearly. The light emanating from light source 20 may be of any color. The light emanating from light source 20 is of uniform color and intensity.

The light source 20 is connected to, and draws electricity from a source of electrical power, including a standalone battery or a universal serial bus connection or computer powerbox.

In one embodiment, the intensity and brightness of light emanating from light source 20 may be adjusted by a user of the invention through the use of a dimmer connected to wire 30, the dimmer controlling the level of electricity flowing through light source 20. In further embodiments, the intensity and brightness of light is controlled and adjusted by a switch or a series of switches or by software controlling the level of electricity flowing through light source 20.

The intensity and brightness of light emanating from light source 20 correspondingly affects the intensity and brightness of projected image 26, and may serve to create greater visual contrast between the portions of projected image 26 in shadow and the portions of projected image 26 in light.

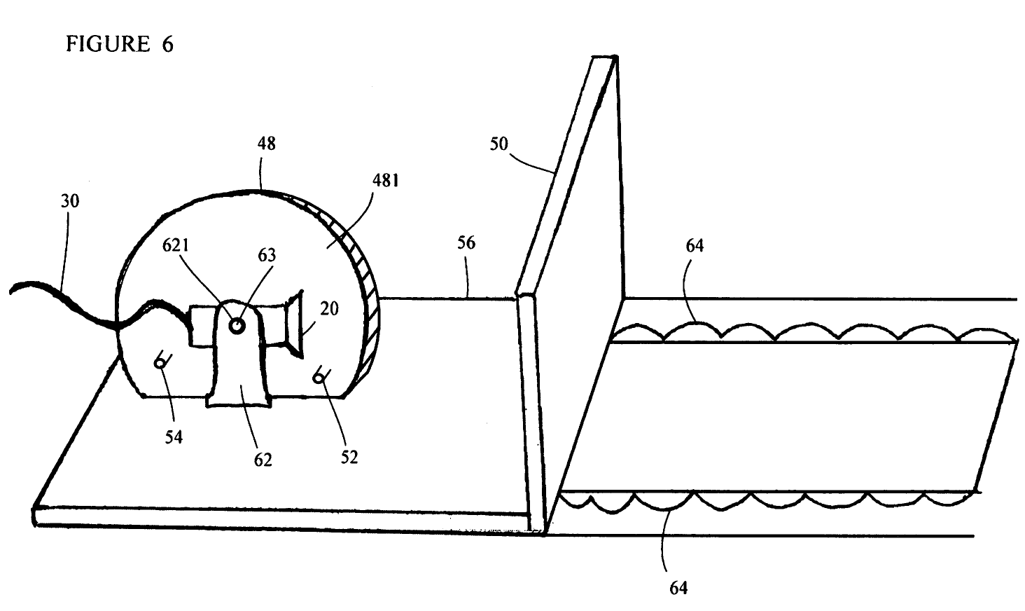

As displayed in FIG. 6, one side of light source 20 is supported by bracket 62; a further and opposite side of light source 20 is supported by and affixed to adjustor wheel 48 in a position so as to enable light source 20 and adjustor wheel 48 to rotate around the center axis (at rod 63) of adjustor wheel 48. As shown in FIG. 6, the lateral center of light source 20, the center of adjustor wheel 48, eye 601 of bracket 60 and eye 621 of bracket 62 are in horizontal alignment. Adjustor wheel 48 rotates around the axis of its center.

From the point of view of FIG. 6, the rotation of adjustor wheel 48 in a clockwise direction will result in light source 20 pointing at a greater angle ‘A’ to the horizontal. Conversely, the rotation of adjustor wheel 48 in an anti-clockwise direction will result in light source 20 pointing at a smaller angle ‘A’ to the horizontal.

Where light emanating from light source 20 is pointed above the upper edge 502 of block 50, the light is reflected off reflector 22 through protective sheet 40, aperture 38 and image insert 24, and a resultant projected image 26 appears. The angle ‘A’ of light source 20 will bear an effect on the size and position of projected image 26.

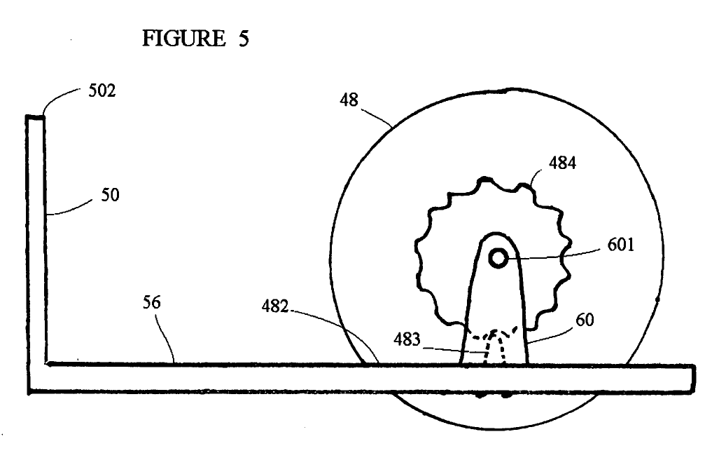

Bracket 60 and bracket 62 are right-angled brackets made of any hard, rigid material. As displayed in FIG. 5 and FIG. 6, each base of bracket 60 and bracket 62 is affixed to the top surface of platform 56 at a predetermined distance from block 50.

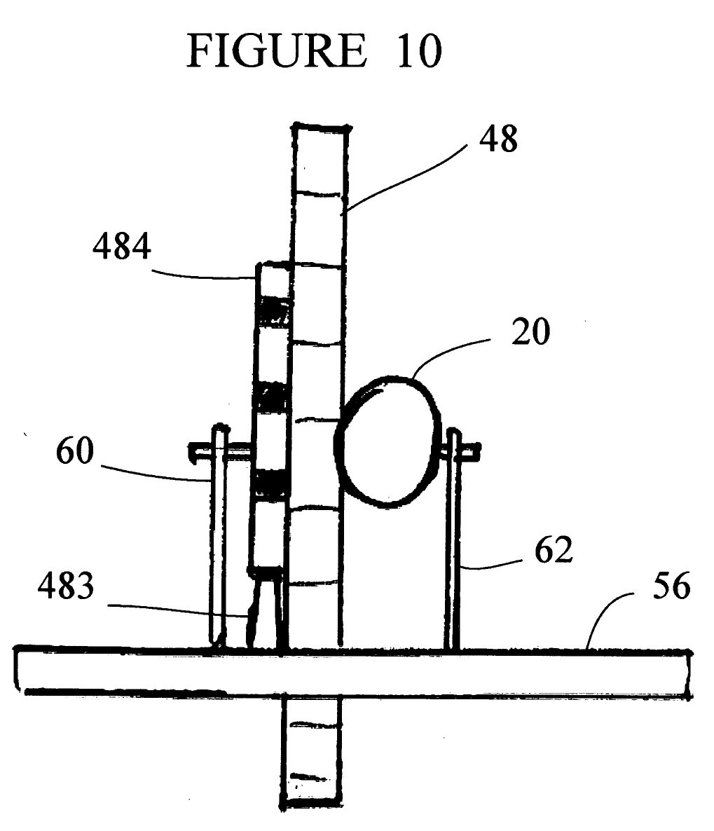

As displayed in FIG. 10, rod 63 is supported by bracket 60 and bracket 62 through eye 601 and eye 621 respectively. Further, rod 63 is a straight rod that supports and runs through light source 20, the center axis of adjustor wheel 48, and the center of cogwheel 484.

As shown in FIG. 6, front stopper 52 and back stopper 54 are each a short cylindrical block made of any hard and rigid material of light weight, one end of each being affixed to surface 481 of wheel 48 at a predetermined position so that one surface of each may make contact with the top surface of platform 56 limiting rotation of wheel 48.

The presence of front stopper 52 prevents light source 20 from being rotated by a user below a predetermined forward angle ‘A’ to the horizontal. Similarly, the presence of back stopper 54 prevents light source 20 from being rotated by a user above a predetermined forward angle ‘A’ to the horizontal.

In FIG. 5, one side of cogwheel 484 is affixed to surface 482 of adjustor wheel 48 in a position such that the center of cogwheel 484 and the center of adjustor wheel 48 are in horizontal alignment. Both adjustor wheel 48 and cogwheel 484 are supported by horizontal rod 63 through their respective centers of axis. Further, both adjustor wheel 48 and cogwheel 484 may rotate around their centers of axis; the rotation of adjustor wheel 48 in one direction by a user of the invention will result in a corresponding rotation of cogwheel 484 in the same direction.

In FIG. 5, stopper 483 is affixed to the top surface of platform 56 and engages between the teeth of cogwheel 484, preventing cogwheel 484 from rotating due to arbitrary forces such as the vibrations experienced by the invention when a user types on alpha-numeric section 44. Stopper 483 is sufficiently flexible to bend and give way to the rotational movement of cogwheel 484 when a user intentionally rotates adjustor wheel 48. In one embodiment of the invention, stopper 483 comprises a flexible foil of a metal such as aluminum with both ends of the foil affixed to the top surface of platform 56.

Platform 56 is a flat, solid, rectangular block made of any rigid and hard material which is light in weight. Affixed to the top surface of platform 56 are the base of bracket 60, the base of bracket 62, the base of front stopper 52 and the base of block 50. Affixed to the base surface of platform 56 is the top surface of push knob 66.

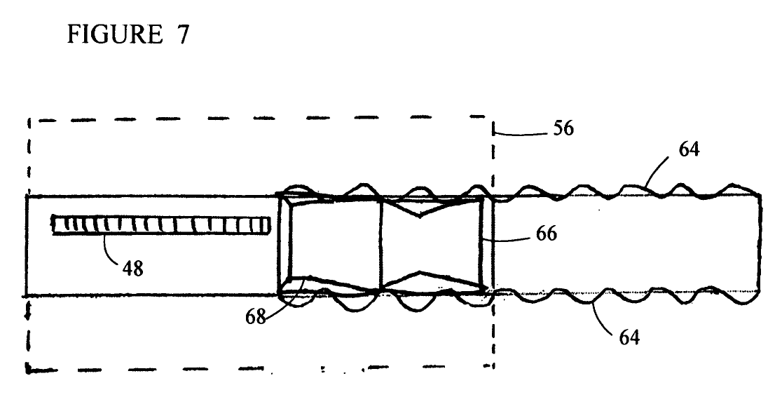

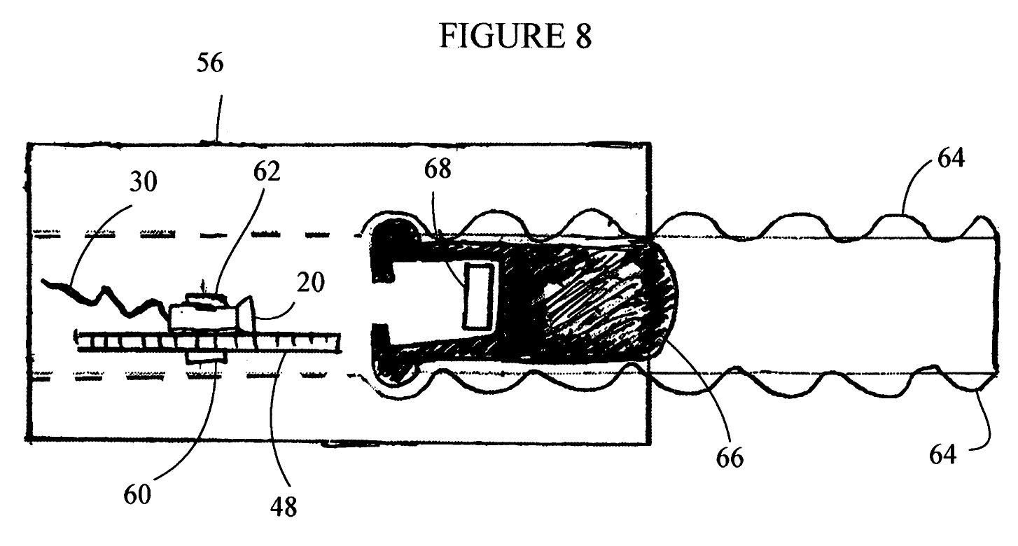

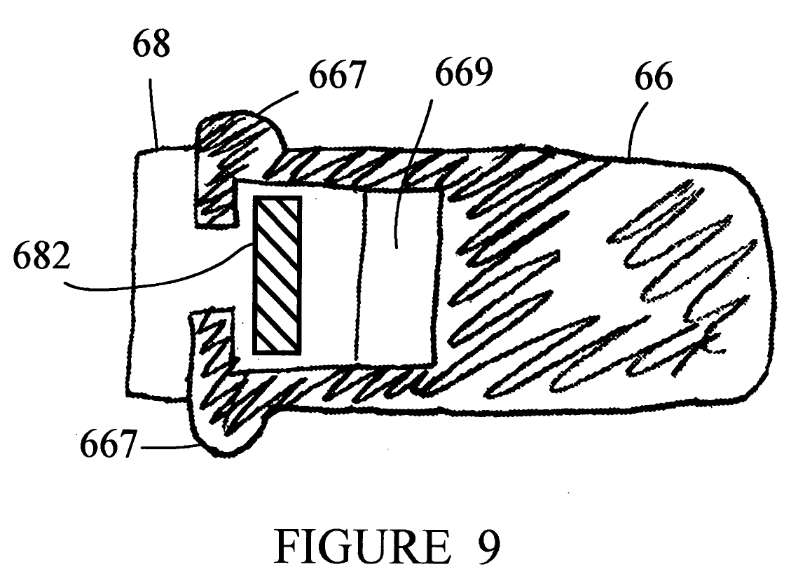

The invention provides for platform 56 to be positioned and to slide longitudinally along housing track 64 where stop knob is in an ‘unlocked’ position, as shown in FIG. 8. Conversely, where stop knob is in a ‘locked’ position, as displayed in FIG. 9, platform 56 is prevented from any longitudinal movement along housing track 64. The weight of push knob 66, platform 56 and all elements supported by platform 56, including light source 20, bracket 60, bracket 62 and adjustor wheel 48, are sufficiently low so as not to impede or have an undesired effect on its movement along housing track 64. The underside of platform 56 is affixed to the top surface of push knob 66, as displayed in FIG. 7.

The position of platform 56 along housing track 64 determines the distance of light source 20 from reflector 22 and aperture 38, and in turn, determines the size, sharpness and location of projected image 26.

As displayed in FIG. 9, push knob 66 consists of a top surface 668, extensions 662, circular knobs 667, protrusions 664, cavity 669, angled surface 661 and main body 663.

Push knob 66 is made of a sufficiently rigid and hard material as to support the weight of itself, platform 56 and all elements supported by platform 56, including light source 20, bracket 60, bracket 62 and adjustor wheel 48.

As displayed in FIGS. 5 to 8, on either longitudinal side of housing track 64 is a row of guiding teeth 646 which are aligned so that each crest on one side is directly opposing a corresponding crest on the other. Housing track 64, groove 642 and guiding teeth 646 collectively form a guideway for pushknob 66 to slide longitudinally along housing track 64.

Extensions 662 of push knob 66 are sufficiently flexible to be pushed inward by guiding teeth 646 and to spring back outwards as it slides along housing track 64, such motion due to the wave-like shapes of guiding teeth 646 to either side of housing track 64.

In FIG. 8 and FIG. 9, stop knob 68 is fitted to push knob 66 in a manner so that the height of protrusion lock 682 is slightly shorter than the width of cavity 669 and so as to enable protrusion lock 682 to slide longitudinally within cavity 669.

In FIG. 9, stop knob is in a ‘lock’ position, preventing extensions 662 from being pushed inwards by guiding teeth 646 and preventing the movement of push knob 66 along housing track 64. The result of this is that the position of light source 20 in relation to reflector 22 and aperture 38 is fixed, thus fixing the size and position of projected image 26.

Conversely, in FIG. 8, stop knob is in an ‘unlock’ position, allowing extensions 662 to be pushed inwards by guiding teeth 646 as push knob 66 slides longitudinally along housing track 64. The result of this is that a user of the invention may adjust the position of light source 20, thus changing the size and position of projected image 26.

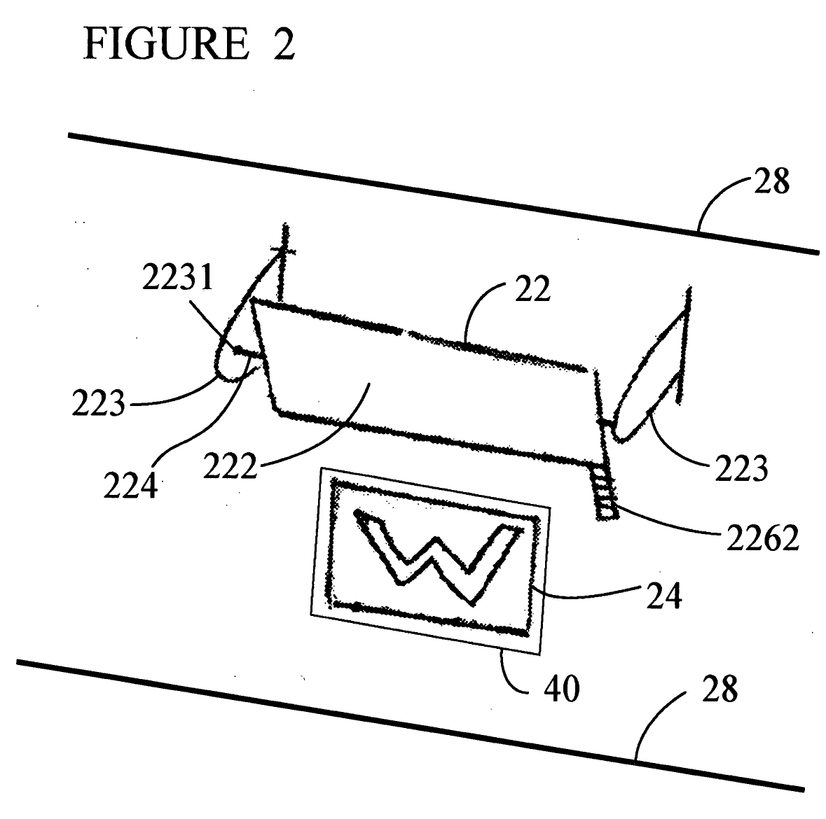

In a preferred embodiment, as shown in FIG. 2 the reflector 22 comprises a back surface 221 and a reflecting surface 222. Reflecting surface 222 is a surface capable of reflecting light in a predictable and consistent manner and includes a conventional smooth mirror or smooth glass. As shown in FIG. 1, reflector 22 resides within the keyboard housing 28 and is oriented so that light from light source 20 may directly reach reflecting surface 222 and so that reflecting surface 222 is facing is a direction towards light source 20.

In a preferred embodiment, the two ends of rod 224 are cylindrical in shape and the middle shaft 2241 of rod 224 is flat and rectangular in shape, as shown in FIG. 5. Middle shaft 2241 is affixed to the back surface 221 of the reflector 22. Middle shaft 2241 is flat so as to increase the area of contact between middle shaft 2241 and back surface 221. This would facilitate the affixation of middle shaft 2241 to back surface 221, whether such affixation is by means of glue, cement or otherwise. The plane and angle of middle shaft 2241 corresponds with the plane and angle of reflector 22. Rod 224 is to be made of a sufficiently strong and rigid material so as to be able to durably support the weight of both lever 226 and reflector 22 and the movement of both lever 226 and reflector 22.

Each end of rod 28 is fitted sufficiently tightly in cavity 2231 so as to provide moderate stability to the position and angle of reflector 22 as well as to prevent any unintentional movement of reflector 22 due to factors such as the following: the weight of lever 226; the weight of reflector 22; and movement and vibration caused by user typing on alpha-numeric section 44. The angle ‘B’ of reflector 22 should not change unless a user of the invention moves lever 226. However, each end of rod 28 should not be fitted so tightly in cavity 2231 as to require that a user of the invention has to use undue strength or force in moving lever 226 or so that it becomes difficult to move lever 226.

Brackets 206 are affixed to the interior side of keyboard housing 28 and are made of sufficiently hard, rigid and strong material as to support the weight of rod 224, reflector 22 and lever 226 and any angular movement of these elements.

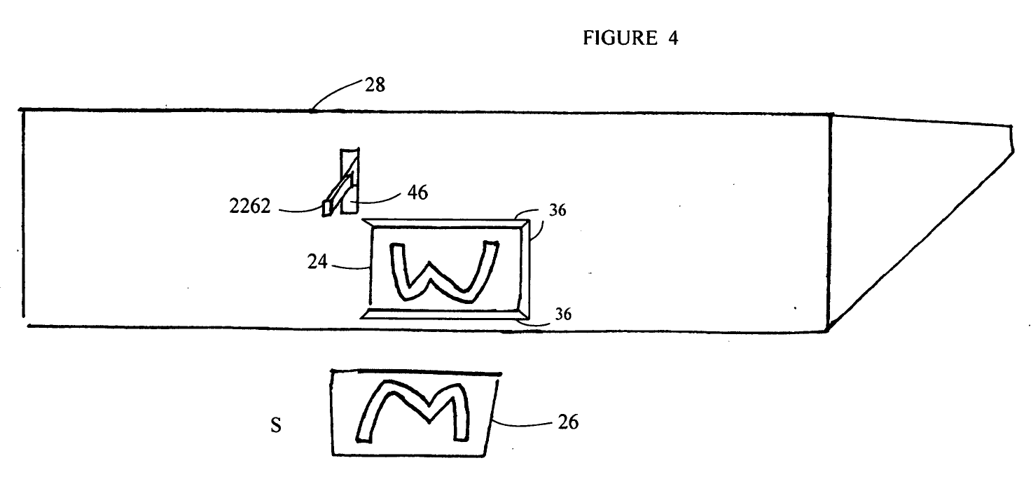

As shown in FIG. 4 and FIG. 5, lever 226 is affixed to the back surface 221 of reflector 22. The flat section 2261 of lever 226 is flat and rectangular in shape, as can be seen in FIG. 5, so as to increase the area of contact between flat section 2261 and back surface 221.

Lever 226 is sufficiently light in weight so as not affect or change the angle or position of reflector 22. Similarly, reflector 22 should be sufficiently light in weight so as not to affect or change it's own angle ‘B’ by its own weight.

As shown in FIG. 4, reflector 22 is placed at an adjustable angle ‘B’ so as to facilitate the reflection of light from light source 20 to aperture 38 at a downward angle in order to facilitate the appearance of the resultant projected image 26 on surface 42.

As such, a user of the present invention is provided with changing the size of image 26 by moving lever 226 up or down accordingly. Moving lever 226 up results in image 26 being laterally expanded; accordingly, moving lever 226 down results in image 26 becoming laterally contracted. Projected image 26 is laterally skewed in accordance with its lateral expansion or contraction.

As shown in FIG. 7, lever 2 is positioned through side slot 46 so that handle 2262 sufficiently protrudes out of the external side of keyboard housing 28 and so that a user of the invention has convenient access to handle 2262. The movement of handle 2262 of lever 2 is limited to vertical angular movements up and down side slot 46.

As shown in FIG. 7, side slot 46 is a rectangular hole in keyboard housing 28. Side slot 46 is positioned above and diagonally to the side of aperture 38 and image insert 24.

As shown in FIG. 7, aperture 38 is a rectangular hole at a side or top surface of the keyboard housing 28 and is covered by protective sheet 40, which is preferably fixed on the inside surface of the keyboard housing. Protective sheet 40 is photo-transparent and allows light from light source 20 to pass through unaltered but prevents any other foreign matter, including dust and dirt, from entering the keyboard housing 28, thus protecting the elements within, such as the printed circuit board from the foreign matter. It is preferred that protective sheet 40 be made of transparent plastic, although thin glass and other photo-transparent material may be used, provided that the nature of the material is such that it does not visibly alter the color and direction of light passing through it. In use the image insert 24 might be removed and changed while the protective sheet 40 would remain in place to keep dust out.

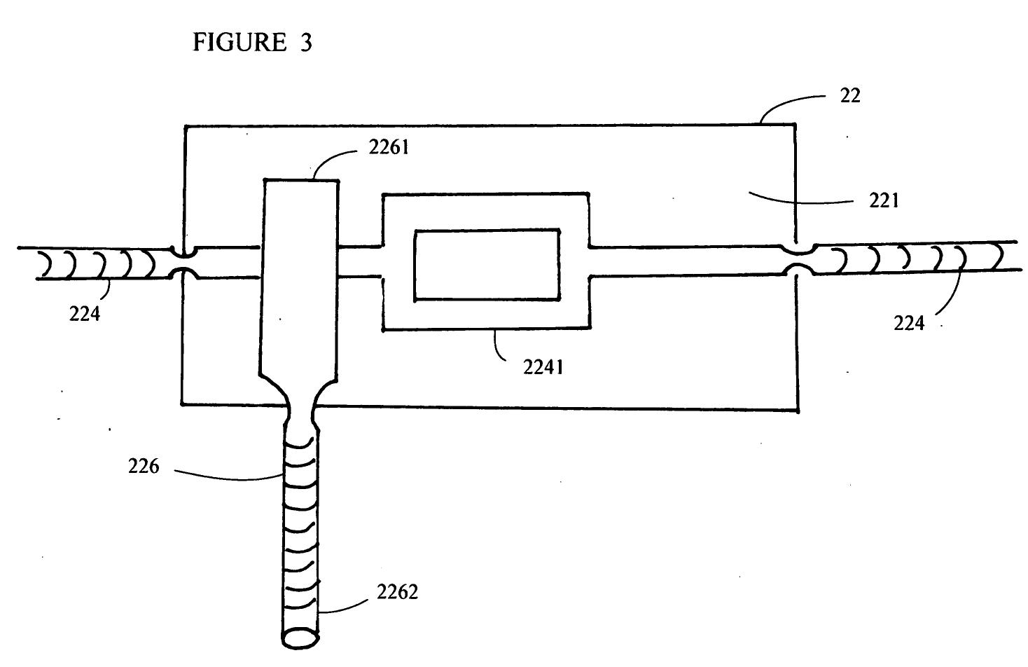

The brackets 36 are rectangular in shape, surrounding the aperture 38 and is located on the outside surface of keyboard housing 28, as shown in FIG. 2 and FIG. 3. Similarly, image insert 24 is rectangular in shape. The brackets 36 are open at the top or a side so as to allow insertion and removal of image insert 24. In a further embodiment, brackets 36 are located on the inside surface of keyboard housing 28 with an open slot at the top surface or a side surface to allow insertion and removal of image insert 24.

In a further embodiment, aperture 38, brackets 36 and image insert 24 may be any other shape, including circular, elliptical, triangular or square.

The image insert 24 is made from any material that is transparent or translucent or with properties that allow the passage of some light through without altering the direction of the light, the material including clear plastics, plastics of any color, cellophane. Image insert 24 is sufficiently thin to be held in place by brackets 36 and may be conveniently inserted or removed from brackets 36.

Image insert 24 may have matter printed or scribed onto either or both of its surfaces, the matter blocking the passage of light through the image insert 24 or allowing only light of a limited band of frequencies through, resulting in a projected image 26 with color. From the viewpoint of facing the aperture 38 from outside the keyboard housing 28, projected image 26 is horizontally inverted to the matter on image insert 24. The specific appearance, color and subject of the matter is immaterial to this invention and may be provided by the manufacturing source of the keyboard or by a user.

The luminosity of projected image 26 is dependent on the amount of light reaching surface 42. The color of projected image 24 is dependent on the color of light from light source 20, the color of the portions of image insert 24 allowing light to pass through and the color of surface 42.

Surface 42 is any surface, whether flat, curved or otherwise, of any color, orientation and material, capable of acting as a surface upon which image 26 is projected. Surface 42 may be horizontal, vertical or otherwise.

Block 17 is affixed to the inside surface of the base of the keyboard housing 28 and is generally located below reflector 22. Block 17 is made of any opaque material capable of preventing any light from passing through it. Block 17 serves to prevent or block any light emanating from light source 20 to travel directly to aperture 38 and possibly result in the compromising of image clarity.

1. A keyboard for use adjacent a surface comprising:
an alpha numeric section;
a light source within a housing of said keyboard;
an image insert;
a reflector within the housing of said keyboard;
wherein the housing of said keyboard features an aperture with image insert placed over said aperture;
means for projecting light from said light source to said reflector;
light reflecting off said reflector to pass through said aperture and through said image insert to form an image on said surface.

2. The keyboard as claimed in claim 1, further comprising a block within the housing of said keyboard at a predetermined distance from said light source and means of preventing light from said light source from reaching said aperture directly.

3. The keyboard as claimed in claim 1 further comprising a lever outside said housing connected to said reflector inside said housing such that a user can adjust said reflector relative to said light source.

4. A keyboard for use on a surface comprising:
a key section;
a light source within a housing of said keyboard;
a partially transparent image insert;
a reflector within the housing of said keyboard;
wherein the housing of said keyboard features an aperture with image insert placed over said aperture;
light reflecting off said reflector to pass through said image insert to form a projected image on said surface.

5. The keyboard of claim 4 wherein said image insert blocks a portion of light from said light source and wherein said projected image is a shadow visually contrasted with light from said light source on said surface.

6. The keyboard of claim 5 wherein a lever external to said housing can be used to adjust said reflector to thereby adjust a position, sharpness and size of said image on said surface.

7. The keyboard of claim 6 wherein said light source is a light emitting diode.

8. The keyboard of claim 6 including an adjuster wheel allowing a user to adjust the amount of light passing through said image insert by allowing a portion of said light to be blocked prior to reaching said image insert.

9. The keyboard of claim 4 wherein said image insert blocks a portion of light from said light source and wherein said projected image is light visually contrasted with shadow.

10. A computer peripheral for use on a surface comprising:
a light source within a housing of said computer peripheral;
an image insert;
a reflector within the housing of said computer peripheral;
wherein the housing of said computer peripheral features an aperture with image insert placed over said aperture;
light reflecting off said reflector to pass through said image insert to form a projected image on said surface.

11. The computer peripheral of claim 10 wherein said reflector is a flat mirror.

12. The computer peripheral of claim 10 wherein said image insert blocks a portion of light from said light source and wherein said projected image is light visually contrasted with shadow.

13. The computer peripheral of claim 10 wherein the size, sharpness and position of said projected image can be adjusted.

14. The computer peripheral of claim 13 wherein a lever on the outside of the housing allows a user to adjust said projected image.

15. The computer peripheral of claim 10 wherein said image insert covers an aperture in said housing and wherein said image insert can be removed from said housing and wherein a protective sheet also covers said aperture and wherein said protective sheet is not removed from said aperture when said image insert is removed.
